(19) United States
(12) Patent Application Publication
(10) Pub. No.: US 2010/0128690 A1
(43) Pub. Date: May 27, 2010

(54) Method and Apparatus for Partitioning a Resource in a Wireless Communication System

(75) Inventors: Sean Michael McBeath, Keller, TX (US); Jack Smith, Valley View, TX (US); Tao Qian, Shenzhen (CN); JueJun Liu, Shenzhen (CN)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/625,994

(22) Filed: Nov. 25, 2009

Related U.S. Application Data
(60) Provisional application No. 61/118,000, filed on Nov. 26, 2008.

(51) Int. Cl. H04W 72/04

(52) U.S. Cl. 370/329

(57) ABSTRACT

In accordance with an embodiment of the present invention, a method of operating a base station includes transmitting a first control channel to a user device. The first control channel has a subframe partition index that partitions resources of an associated subframe into at least one partition. The at least one partition has a size limited to only a set of possible partition sizes.

This patent application claims priority to U.S. Provisional Application No. 61/118,000 filed on Nov. 26, 2008, entitled “Method and Apparatus for Partitioning a Resource in a Wireless Communication System,” which application is hereby incorporated by reference herein.

### TECHNICAL FIELD

The present invention relates generally to wireless communication systems, and more particularly to a system and method for partitioning a resource in a wireless communications system.

### BACKGROUND

Wireless communication systems are widely used to provide voice and data services for multiple users using a variety of access terminals such as cellular telephones, laptop computers and various multimedia devices. Such communications systems can encompass local area networks, such as IEEE 801.11 networks, cellular telephone and/or mobile broadband networks. The communication system can use one or more multiple access techniques, such as Frequency Division Multiple Access (FDMA), Time Division Multiple Access (TDMA), Code Division Multiple Access (CDMA), Orthogonal Frequency Division Multiple Access (OFDMA), Single Carrier Frequency Division Multiple Access (SC-FDMA) and others. Mobile broadband networks can conform to a number of system types or partnerships such as, General Packet Radio Service (GPRS), 3rd-Generation standards (3G), Worldwide Interoperability for Microwave Access (WiMAX), Universal Mobile Telecommunications System (UMTS), the 3rd Generation Partnership Project (3GPP), Evolution-Data Optimized EV-DO, or Long Term Evolution (LTE).

In an OFDMA communication system, the time-frequency resources of the system are shared among a plurality of mobile stations. The base station assigns resources to mobile stations using an assignment message, which is transmitted as part of a control channel. It is known to partition a set of resources into one or more resource partitions to facilitate resource allocation, control channel transmission, and the like. In prior art systems, however, the overhead associated with transmitting the resource partition information can be high.

FIG. 1 is a wireless communications network comprising a plurality of base stations (BS) 110 providing voice and/or data wireless communication service to a plurality of mobile stations (MS) 120. The BS is also sometimes referred to by other names such as access network (AN), access point (AP), Node-B, etc. Each BS 110 has a corresponding coverage area 130. Referring to FIG. 1, each base station includes a scheduler 140 for allocating radio resources to the mobile stations. Exemplary wireless communication systems include, but are not limited to, Evolved Universal Terrestrial Radio Access (E-UTRA) networks, Ultra Mobile Broadband (UMB) networks, IEEE 802.16 networks, and other OFDMA based networks. In some embodiments, the network is based on a multiple access scheme other than OFDMA. For example, the network can be a frequency division multiplex access (FDMA) network wherein the time-frequency resources are divided into frequency intervals over a certain time interval, a time division multiplex access (TDMA) network wherein the time-frequency resources are divided into time intervals over a certain frequency interval, and a code division multiplex access (CDMA) network wherein the resources are divided into orthogonal or pseudo-orthogonal codes over a certain time-frequency interval.

FIG. 2 illustrates one base station and several mobile stations from the wireless communications network of FIG. 1. The base station has three coverage areas, one of which is shown 270. The coverage area is sometime referred to as a sector. Six mobile stations 200, 210, 220, 230, 240, 250 are in the shown coverage area. The base station 260 typically assigns each mobile station one or more connection identifiers (CID) (or another similar identifier) to facilitate time-frequency resource assignment. The CID assignment can be transmitted from the base station to the mobile station on a control channel, can be permanently stored at the mobile station, or derived based on a mobile station or base station parameter.

FIG. 3 illustrates an example set of OFDMA time-frequency radio resources. In OFDMA systems, the time-frequency resources are divided into OFDM symbols and OFDM subcarriers for allocation by the base station scheduler to the mobile stations. In an example OFDMA system, the OFDM subcarriers are approximately 10 kHz apart and the duration of each OFDM symbol is approximately 100 μsec. FIG. 3 illustrates one 5 msec frame of an OFDMA system, such as that defined by the IEEE 802.16e standard. Note that 5 msec is one frame duration and that other frame durations are possible. Referring again to FIG. 3, resources in the time domain (x-axis) are divided into 48 OFDM symbols 320. In the frequency domain (y-axis), the resources are divided into multiple subchannels (not shown), wherein the size of the subchannel depends on the subcarrier permutation scheme. A subcarrier permutation scheme is a mapping from logical subchannels to physical subcarriers. Downlink (DL) partial usage of subcarriers (PUSC), DL full usage of subcarriers (FUSC), and uplink (UL) PUSC are exemplary subcarrier permutations schemes defined in the IEEE 802.16 standard. Other permutation schemes are also defined in the IEEE 802.16 standard, so DL PUSC, DL FUSC, and UL PUSC are merely used to illustrate the invention. For DL PUSC, in a 5 MHz bandwidth, there are 360 data subcarriers divided into 15 subchannels, wherein each subchannel has 24 data subcarriers. For DL PUSC, the base station must assign an even number of OFDM symbols for each subchannel. For DL FUSC, in a 5 MHz bandwidth, there are 384 data subcarriers divided into 8 subchannels, wherein each subchannel has 48 data subcarriers. For UL PUSC, in a 5 MHz bandwidth, there are 408 subcarriers (data plus pilot) divided into 17 subchannels, wherein each subchannel has 24 subcarriers (16 data plus 8 pilot). For UL PUSC, the number of OFDM symbols for each subchannel is a multiple of 3. Note that the subchannels are a logical representation of the time-frequency resources of the system. Each logical time-frequency resource (subchannel) maps to a physical time-frequency resource. The mapping of logical time-frequency resources to physical time-frequency resources depends on which subcarrier permutation is being used. The mapping of logical time-frequency resource to physical time-frequency resources can change with time and can depend on one or more parameters defined by the system.

FIGS. 4 and 5 illustrate an example time-frequency structure. Referring to FIG. 4, the frame of FIG. 3 is divided into 8 equal portions, denoted subframes 410. Each subframe can be designated as a downlink subframe or an uplink subframe and is comprised of 6 OFDM symbols 420. The number of symbols in each subframe may vary as the OFDM numerology varies, the bandwidth varies, the TDD time gaps vary, and the like. The time-frequency resources of each subframe may be represented by a channel tree.

FIG. 5 illustrates a series of subframes. Referring to FIG. 5, the frame is divided into a downlink frame and an uplink frame. The downlink frame is divided into 4 subframes, denoted DL₀, DL₁, DL₂, and DL₃ and numbered 000, 001, 010 and 011. Similarly, the uplink frame is divided into 4 subframes, denoted UL₀, UL₁, UL₂, and UL₃ and numbered 000, 001, 010 and 011. The subframe structure may be used to make persistent assignments. For example, if the persistent assignment period is 4 frames, then the assigned time-frequency resource in one or more subframes repeats every four frames. Similarly, if the persistent assignment period is one frame, then the assigned time-frequency resource in one or more subframes repeats every frame.

As an additional example, in an FDD system with 8 subframes, the numbering of subframes for the DL can be 000, 001, 010, 011, 100, 101, 110, and 111, and the numbering of subframes for the UL can be 000, 001, 010, 011, 100, 101, 110, and 111.

In FIG. 5, the frequency domain structure is illustrated for subframe 010 in enclosure 505. DL₂ is divided into N subchannels 510. Each subchannel is 6 OFMD symbols in the time domain and SC subcarriers in the frequency domain, where a typical value of SC is 18. As previously discussed, the value of SC is dependent on the subcarrier permutation. The BS allocates one or more subchannels to a mobile station in order to communicate with the mobile station.

FIG. 6 depicts a repeating sequence of frames. Referring to FIG. 6, a frame is defined as 5 msec and contains both DL and UL sub-frames. A superframe is defined as 20 msec and contains four frames (four pairs of DL and UL sub-frames). The first DL sub-frame 610 is denoted DL₁, the second DL sub-frame is denoted DL₂ 612, the third DL sub-frame is denoted DL₃ 616, the fourth DL sub-frame is denoted DL₄ 618, and the fifth DL sub-frame is denoted DL₁ 620. In this example, the timing of some broadcast information is associated with the superframe timing. For example, broadcast information 605 can be transmitted in the first subframe of the first frame of the superframe.

Partitioning resources of a particular subframe into one or more partitions in order to enable different traffic types, reduces control channel overhead, enables fractional frequency reuse groups, etc. To partition the resources of a particular subframe, the BS transmits a subframe partition index to the set of mobile stations with which it is communicating in the subframe. The mobile stations then use this subframe partition index to determine their resource allocation or isolate their resource allocation to be contained within a particular resource partition. FIG. 7A illustrates a particular indexing scheme to partition a resource into at most four partitions. In FIG. 7A, there are four partitions, denoted a, b, c, and d, wherein each partition is associated with an index. The number of subchannels in each partition (a, b, c, and d), for a particular index, is represented by the numerical value in the table. For example, for index 10, there are four partitions, the first has one subchannel, the second has one subchannel, the third has one subchannel, and the fourth has 5 subchannels. Upon reception of this index at the MS, the mobile stations know the size of each of these four partitions and can use this information to determine or isolate their resource allocation.

The subframe partition scheme of FIG. 7A requires a maximum number of bits to represent subchannels, thereby requiring unnecessary overhead. For example, for the case when there are 24 subchannels and four partitions, there are 169 different resource partitions. The overhead required to transmit an indication of which of the 169 resource partitions is being used in the current subframe can be prohibitive, since it is transmitted to all of the users with which the base station is communicating in the subframe. Thus, there is a need to reduce the overhead associated with transmitting a subframe partition.

### SUMMARY OF THE INVENTION

In accordance with an embodiment of the present invention, a method of operating a base station includes transmitting a first control channel to a user device. The first control channel has a subframe partition index that partitions resources of an associated subframe into at least one partition. The at least one partition has a size limited to only a set of possible partition sizes.

In accordance with another embodiment of the present invention, a method of operating a base station includes partitioning resources of an associated subframe into at least one partition, generating a subframe partition index from a set of equations configured to transform the at least one partition to a corresponding subframe index, and transmitting a first control channel to a user device. The first control channel includes the subframe partition index

In accordance with a further embodiment of the present invention, a wireless base station includes a transmitter configured to transmit a first control channel to a user device. The first control channel has a subframe partition index, which partitions resources of an associated subframe into at least one partition. The at least one partition has a size limited to only a set of possible partition sizes.

In accordance with an embodiment of the present invention, a wireless base station includes a transmitter configured to transmit a first control channel to a user device. The first control channel has a subframe partition index, which partitions resources of an associated subframe into at least one partition. The wireless base station is configured to generate the subframe partition index from a set of equations and the sizes of the at least one partition.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a wireless communications network;

FIG. 2 illustrates a base station and several mobile stations from a wireless communications network;

FIG. 3 illustrates an example set of OFDMA time-frequency radio resources;

FIGS. 4-6 illustrate an example time-frequency structure;

FIG. 7A illustrates a subframe partition;

FIGS. 7B and 7C illustrate subframe partitions in accordance with embodiments of the present invention;

FIG. 8 illustrates an example control message in accordance with one embodiment of the present invention;

FIG. 9 illustrates an example assignment message in accordance with one embodiment of the present invention;

FIG. 10 illustrates an example subframe partition based on the subframe partition of FIG. 7C;

FIG. 11 is a flow chart for base station operation in accordance with one embodiment of the present invention;

FIG. 12 is a flow chart for mobile station operation in accordance with one embodiment of the present invention;

FIG. 13 illustrates a block diagram of an embodiment base station; and

FIG. 14 illustrates a block diagram of an embodiment user device.

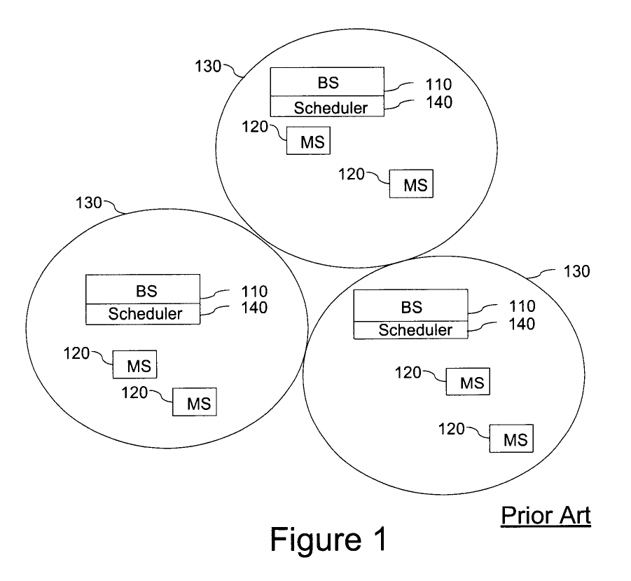

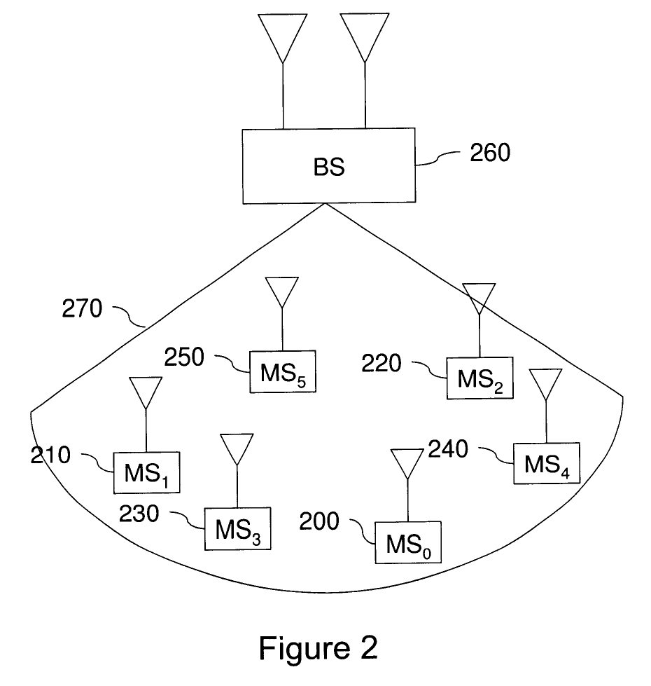

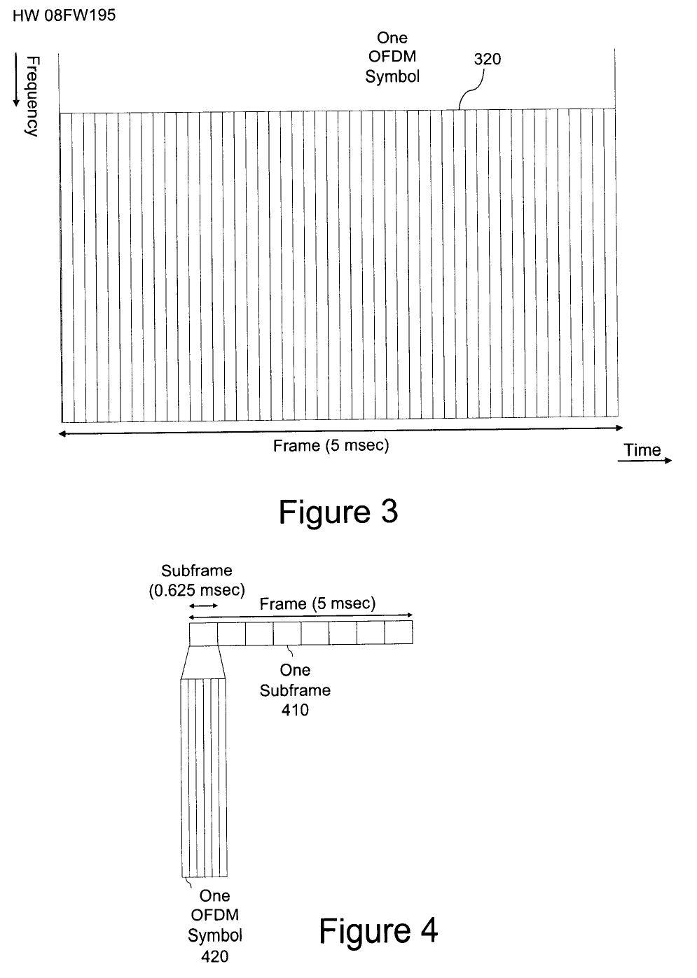

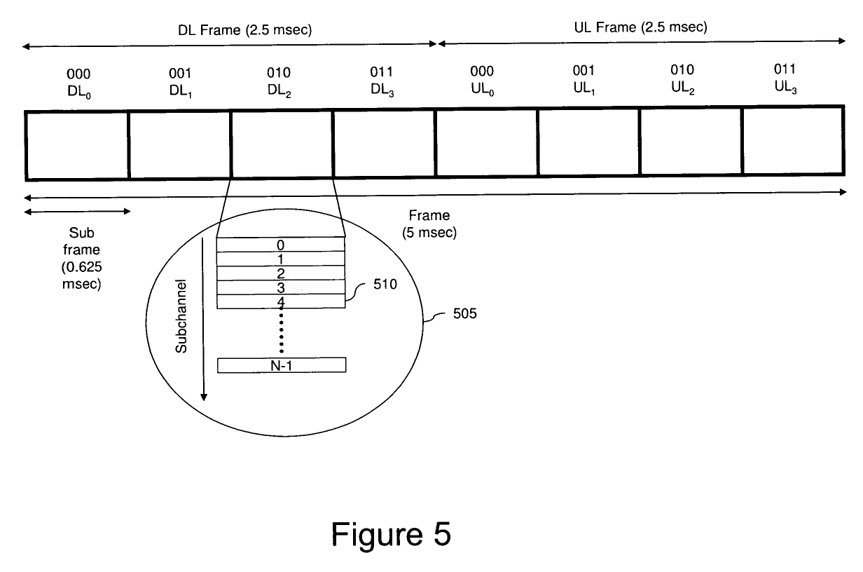

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of various embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to various embodiments in a specific context, namely resource management in wireless networks. The invention may also be applied to resource management in other types of networks. In embodiments of the present invention, memory efficient resource partitioning is provided.

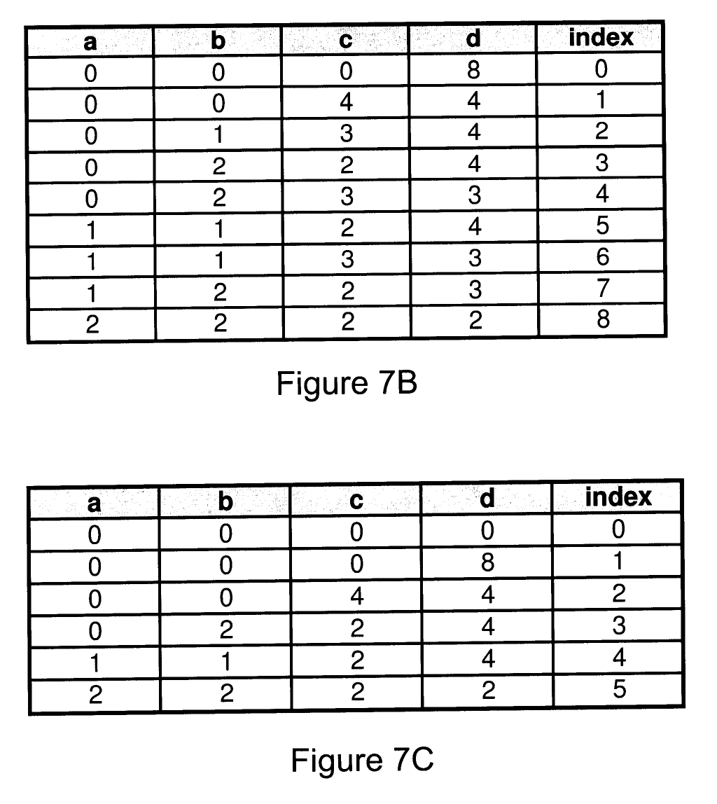

FIGS. 7B and 7C illustrate subframe partitions in accordance with different embodiments of the present invention. In FIG. 7B, the subframe partitions are limited in size to 0, 1, 2, 3, 4, and 8 subchannels. This is compared to FIG. 7A wherein the subframe partitions are not limited and can have values of 0, 1, 2, 3, 4, 5, 6, 7, and 8 subchannels. The embodiment limitation of FIG. 7B is particularly suitable for wireless systems, since it provides the necessary granularity at the smaller partition sizes, while limiting the granularity at the larger partition sizes. In embodiments, by limiting the partition sizes in this way, the number of combinations is reduced from 15 to 9. This does not result in any bit savings for this particular example (4 bits are needed to index the table in each case). However, for the case when there are 24 subchannels and 4 partitions, embodiment schemes reduce the number of combinations from 169 to 8, for the case when the possible partition sizes in the second case are (0, 1, 2, 3, 4, 8, 16, 24) which is a significant reduction in overhead. Alternatively, the limited partition sizes can be used to provide more partitions using the same overhead. For example, instead of providing four partitions with maximum flexibility, as in FIG. 7A, limiting the partitions to fixed sizes can provide more partitions in some embodiments.

FIG. 7C, illustrates an embodiment subframe where resource partition sizes are limited to 0, 1, 2, 4, and 8 subchannels. This results in 6 possible combinations, which requires fewer bits to index than the schemes of FIGS. 7A and 7B.

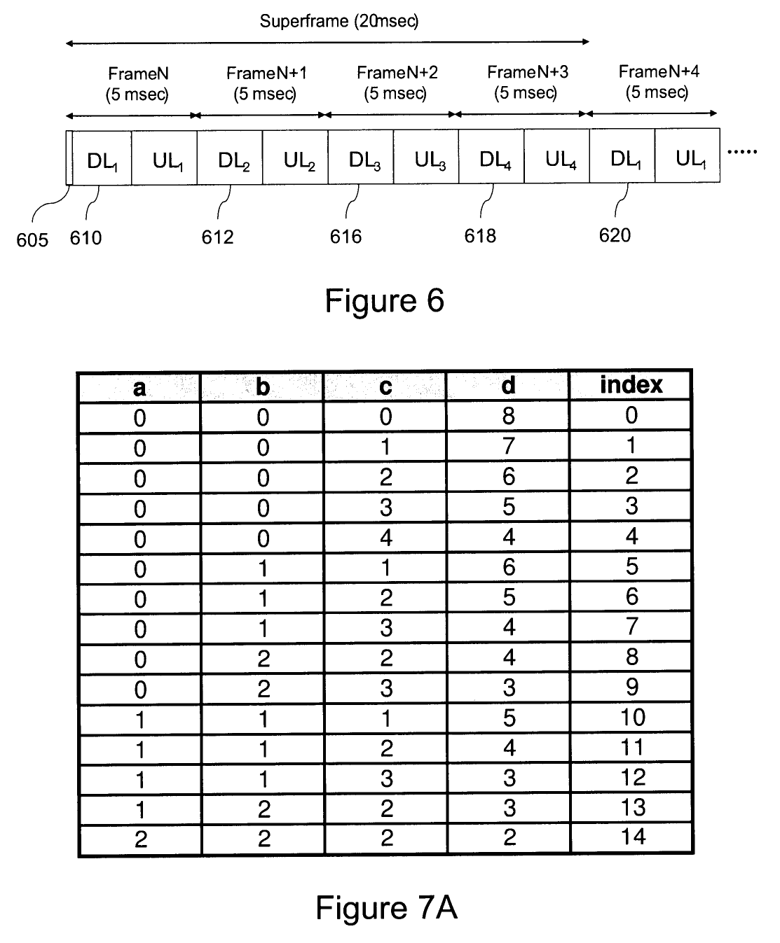

Any set of limited partition sizes can be used. The ones described herein are only examples. For example, the possible partition sizes can be (0, 1, 2, 3, 4, 6, 10, and 16) for the case when there are 16 total subchannels. The candidate partition sizes can change based on the total number of subchannels. In some embodiments, the BS indicates which set of candidate partition sizes are being used in a broadcast control channel message, for example the broadcast message 605 of FIG. 6, thereby allowing the BS scheduler flexibility in determining the tradeoff between partition granularity and control channel overhead. In some embodiments, the limited partition sizes are the same sizes as provided by a channel tree for resource allocation. For example, considering 24 total subchannels, if the channel tree provides resource allocation sizes of 1, 2, 3, 4, 6, 10, 18, and 24 subchannels, then the partition sizes can be limited to this same set plus the value of 0. In this particular case, the particular channel tree is the annular channel tree.

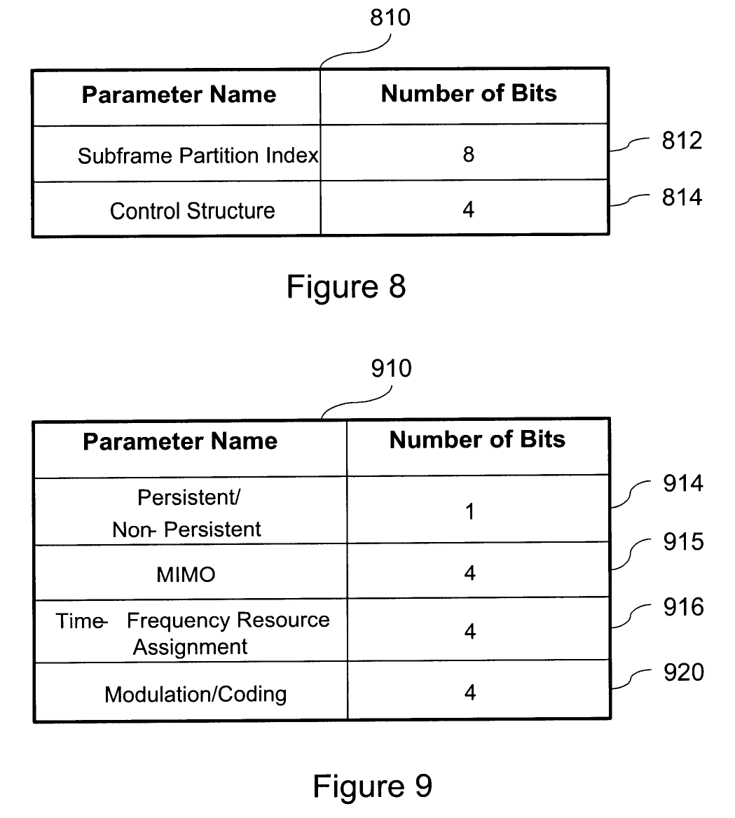

FIG. 8 illustrates an example multicast control message. The control message 810 contains two fields 812-814 and is used by the base station to indicate the subframe partition index 812 and the control structure field 814. The subframe partition index 812 indexes a table such as those illustrated in FIGS. 7A-7C and is used as an input/output to an embodiment equation such as will be described in more detail later. The control structure field 814 describes how the control is partitioned. For example, the control structure field indicates which control blocks use QPSK modulation and which control blocks use 16-QAM modulation. In some embodiments, the control message 810 is encoded and CRC protected. In alternate embodiments, the control message 810 is not CRC protected.

In some embodiments, the control message 810 is transmitted in each DL subframe. The control message 810 may be repeated for DL traffic and UL traffic. In some embodiments, the control message 810 is transmitted every K subframes and the resource partitions are valid until the next occurrence of the control message 810.

FIG. 9 illustrates an example assignment message in accordance with an embodiment of the present invention. The assignment message 910 is associated with a particular partition. This association can be implicit or explicit. In some embodiments, the assignment message 910 is transmitted within the resource partition itself, thereby providing an implicit association. The persistent/non-persistent field 914 is a 1-bit field used for indicating if the assignment is persistent or non-persistent. The MIMO field 915 is a 4 bit indication of the multiple-input multiple-output (MIMO) antenna scheme used at the base station or mobile station. The time-frequency resource assignment field 916 is a 4-bit field for indicating a particular time-frequency resource assignment. In some embodiments, this field corresponds to a channel tree index, where each channel tree index represents a portion of the total time-frequency resources. In some embodiments, the time-frequency resource assignment field 916 is omitted, and the time-frequency resource assigned to the MS is the entire associated resource partition. In some embodiments, the time-frequency resource assignment field 916 indexes the resources of the associated partition. In some embodiments, the time-frequency resource assignment field 916 is a number of resources within the partition. The modulation/coding field 920 is a 4-bit field for indicating the modulation and coding of the packet. The number of bits for each field can change depending on the system and the associated parameters. Further, additional fields may be needed in some embodiments and fewer fields may be needed in some embodiments.

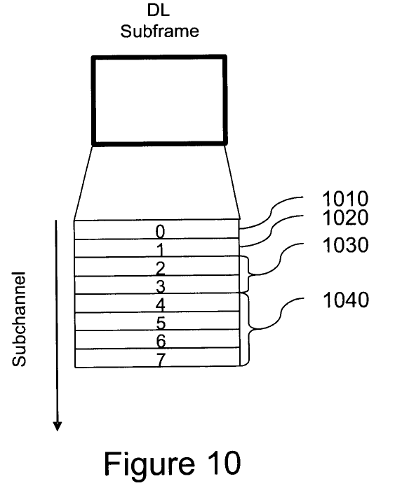

FIG. 10 illustrates an example subframe partition based on the subframe partition of FIG. 7C. In FIG. 10, a particular DL subframe is partitioned by the BS in order to meet the time-frequency resource requirements of the mobile stations. The subframe contains 8 subchannels which are partitioned into one subchannel 1010, one subchannel 1020, two subchannels 1030, and four subchannels 1040 by transmitting an indication of index 4 as illustrated in FIG. 7C. This indication can be transmitted using a control message, such as the control message of FIG. 8.

Depending on the number of subchannels and the number of partitions, the number of combinations for partitioning the subchannels into the partitions can be large, potentially greater than 1000 combinations. Therefore, embodiment systems and methods provide a simple, memory efficient way, for the BS and MS to transform the partitions into a subframe partition index and visa versa. In one embodiment of the present invention, a set of equations are used to transform the partitions to the corresponding subframe partition index. At the BS side, the BS first determines the values of a, b, c, and d for the case when there are four partitions. The BS then uses the following procedures to transform a, b, c, and d into an index. The equations use 24 total subchannels for illustration, therefore it is implicit that d=24−a−d−c. The equations are valid of the scheme with resource partition sizes beginning at 0 and ending at the total number of resources, inclusive as in FIG. 7A.

$$if a = 0 , b = 0 , I = c$$

$$Else if a = 0 , b > 0 ;$$

$$I = {\sum }_{j = 0}^{b - 1} ( floor ( ( 24 - j ) / 2 ) - j + 1 ) + ( c - b )$$

$$Else if a > 0 , b > 0 ( b > a )$$

$$I = {\sum }_{i = 0}^{a - 1} {\sum }_{j = i}^{floor ( ( 24 - i ) / 3 )} ( floor ( ( 24 - i - j ) / 2 ) - j + 1 ) + {\sum }_{j = a}^{b - 1} ( floor ( ( 24 - a - j ) / 2 ) - j + 1 ) + ( c - b ) \\ Else if a > 0 , b > 0 , a = b \\ I = {\sum }_{i = 0}^{a - 1} {\sum }_{j = i}^{floor ( ( 24 - i ) / 3 )} ( floor ( ( 24 - i - j ) / 2 ) - j + 1 ) + ( c - b )$$

The equations can be formulated into pseudo-code as follows:

int function(int a, int b , int c , int d)
{

int result = 0;
if(a==0 && b==0)
{

result = c;

}
else if(a==0 && b>0)
{

for(int j=0; j<b ; j++)
{

result = result+((24−j)/2−j+1);

}
result = result+(c−b);

}
else if(a>0 && b>0)
{

if (b>a)
{

for(int i = 0 ; i < a ; i++)
{

for(int j=i; j <= (24−i)/3 ; j ++)
{

result = result +((24−i−j)/2−j+1);

}

}
for(int j=a; j < b ; j++)
{

result = result + ((24−a−j)/2−j+1);

}
result = result + (c−b);

}
else if (a==b)
{

for(int i = 0 ; i < a ; i++)
{

for(int j = i ; j <= (24−i)/3 ; j++)
{

result = result + ((24−i−j)/2−j+1);

}

}
result = result + (c−b);

}
else
{

cout<<“ error! ”<<endl;

}

}
else
{

cout<<“ error! ”<<endl;

}
return result;

}.

It should be understood that the embodiment pseudo-code shown above can be implemented using a variety of different systems and methods including software of various languages, such as C++, or by hardware. For example, a hardware description language could be used to implement a hardware version of the above pseudo-code in some embodiments.

At the MS side, the procedures are reversed. The equations can be extended to any number of partitions and any total number of subchannels. In an embodiment, partitions are allocated at the BS and the MS determines the partitions based on received data from the BS, and the MS uses resources within only one of these partitions.

In the formulation below, the number of subchannels is defined as M and there are five partitions, a, b, c, d, and e. The output of the equations and pseudo code (result) is the subframe partition index, and the inputs are the sizes of the partitions. Because there are M subchannels, the number of subchannels in partition e is M−a−b−c−d.

$$if a = 0 , b = 0 , c = 0 I = d ;$$

$$Else if a = 0 , b = 0 , c > 0$$

$$I = {\sum }_{i = 0}^{c - 1} ( floor ( ( M - i ) / 2 ) - i + 1 ) + ( d - c ) ;$$

$$Else if a = 0 , b > 0 , c > 0 , b = c$$

$$I = {\sum }_{i = 0}^{b - 1} {\sum }_{j = i}^{floor ( ( M - i ) / 3 )} ( floor ( ( M - i - j ) / 2 ) - j + 1 ) + ( d - c ) ;$$

$$Else if a = 0 , b > 0 , c > 0 , b < c$$

$$I = {\sum }_{i = 0}^{b - 1} {\sum }_{j = i}^{floor ( ( M - i ) / 3 )} ( floor ( ( M - i - j ) / 2 ) - j + 1 ) + {\sum }_{j = b}^{c - 1} ( floor ( M - b - j ) / 2 - j + 1 ) + ( d - c )$$

$$Else if a > 0 , b > 0 , c > 0 \&\& a = b = c$$

$$I = {\sum }_{i = 0}^{a - 1} {{\sum }_{j - i}}^{floor ( ( M - i ) / 4 )} {\sum }_{k = j}^{floor ( ( M - i - j ) / 3 )} ( floor ( M - i - j - k ) / 2 - k + 1 ) + ( d - c )$$

$$Else if a > 0 , b > 0 , c > 0 \&\& a = b < c$$

$$I = {\sum }_{i = 0}^{a - 1} {{\sum }_{j - i}}^{floor ( ( M - i ) / 4 )} {\sum }_{k = j}^{floor ( ( M - i - j ) / 3 )} ( floor ( M - i - j - k ) / 2 - k + 1 ) + {\sum }_{k = a}^{c - 1} ( floor ( ( M - a - b - k ) / 2 ) - k + 1 ) + ( d - c )$$

$$Else if a > 0 , b > 0 , c > 0 \&\& a < b < c$$

$$I = {\sum }_{i = 0}^{a - 1} {\sum }_{j - i}^{floor ( ( M - i ) / 4 )} {\sum }_{k = j}^{floor ( ( M - i - j ) / 3 )} ( floor ( M - i - j - k ) / 2 - k + 1 ) + {\sum }_{k = b}^{c - 1} ( floor ( ( M - a - b - k ) / 2 ) - k + 1 ) + {\sum }_{j = a}^{b - 1} {\sum }_{k = j}^{floor ( ( M - a - j ) / 3 )} floor ( ( M - a - j - k ) / 2 - k + 1 ) + ( d - c )$$

$$Else if a > 0 , b > 0 , c > 0 \&\& a < b = c \\ I = {\sum }_{i = 0}^{a - 1} {\sum }_{j - i}^{floor ( ( M - i ) / 4 )} {\sum }_{k = j}^{floor ( ( M - i - j ) / 3 )} ( floor ( M - i - j - k ) / 2 - k + 1 ) + {\sum }_{j = a}^{b - 1} {\sum }_{k = j}^{floor ( ( M - a - j ) / 3 )} floor ( ( M - a - j - k ) / 2 - k + 1 ) + ( d - c )$$

The equations can be formulated into pseudo-code as follows:

int func(int a, int b, int c, int d, int e, int M)
{

int result = 0;
if(a==0 && b ==0 && c==0)
{

result = d;

}
else if(a==0 && b ==0 && c>0)
{

for(int i =0 ; i < c ; i++)
{

result = result + ((M−i)/2−i+1);

}
result = result + (d−c);

}
else if(a==0 && b> 0 && c>0)
{

if(b==c)
{

for(int i=0; i < b ; i++)
{

for(int j = i ; j <=(M−i)/3 ; j++)
{

result = result+ (M−i−j)/2 −j+1;

}

}
result = result + (d−c);

}
else if(b<c)
{

for(int i = 0 ; i < b ; i++)
{

for(int j = i ; j <= (M−i)/3; j++)
{

result = result + (M−i−j)/2 − j + 1;

}

}
for(int j = b ; j < c ; j++)
{

result = result + ((M−b−j)/2 −j +1);

}
result = result + (d−c);

}

}
else if (a >0 && b >0 && c >0)
{

if(a==b && b==c)
{

for(int i = 0 ; i < a ; i++)
{

for(int j = i ; j <= (M−i)/4 ; j++)
{

for(int k = j ; k <=(M−i−j)/3 ; k++)
{

result = result + (M−i−j−k)/2−k+1;

}

}

}
result = result + (d−c);

}
else if(a==b && b < c)
{

for(int i = 0 ; i < a ; i++)
{

for(int j = i ; j <=(M−i)/4 ; j++)
{

for(int k = j ; k <= (M−i−j)/3 ; k++)
{

result = result + (M−i−j−k)/2 −

k+1;

}

}

}
for(int k = a ; k < c ; k++)
{

result = result + (M−a−b−k)/2 − k+1;

}
result = result + (d−c);

}
else if( a < b && b < c)
{

for(int i = 0 ; i < a ; i++)
{

for(int j = i ; j <=(M−i)/4 ; j++)
{

for(int k = j ; k <=(M−i−j)/3 ; k++)
{

result = result + (M−i−j−k)/2 −

k+1;

}

}

}
for(int j = a ; j < b ; j++)
{

for(int k = j ; k <= (M − a−j)/3 ; k++)
{

result = result + (M−a−j−k)/2 − k +1;

}

}
for( int k = b ; k < c ; k++)
{

result = result + (M−a−b−k)/2 − k+1;

}
result = result + (d−c);

}
else if(a < b && b == c)
{

for(int i = 0 ; i < a ; i++)
{

for(int j = i ; j <=(M−i)/4 ; j++)
{

for(int k = j ; k <=(M−i−j)/3 ; k++)
{

result = result + (M−i−j−k)/2 −

k+1;

}

}

}
for(int j = a ; j < b ; j++)
{

for(int k = j ; k <= (M − a−j)/3 ; k++)
{

result = result + (M−a−j−k)/2 − k +1;

}

}
result = result + (d−c);

}
else
{

cout<<“ error set!”<<endl;

}

}
return result;

}

Again, it should be understood that the embodiment pseudo-code shown above can be implemented using a variety of different systems and methods including software of various languages, such as C++, or by hardware. For example, a hardware description language could be used to implement a hardware version of the above pseudo-code in some embodiments.

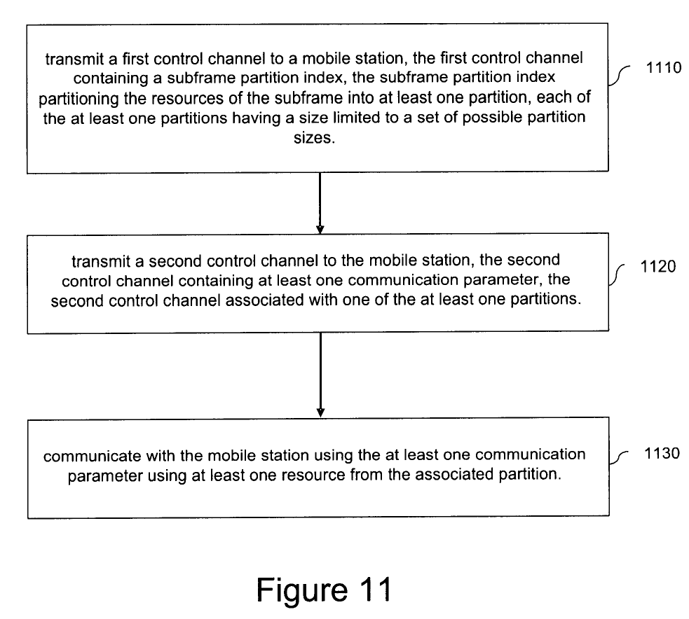

FIG. 11 is a flow chart for base station operation in accordance with one embodiment of the present invention. At step 1110, the base station transmits a first control channel to a mobile station. The first control channel contains a subframe partition index, where the subframe partition index partitions the resources of the subframe into at least one partition. Each of the at least one partitions having a size limited to a set of possible partition sizes. In some embodiments, the set of possible allocation sizes is different than the set beginning at zero and ending at the total number of resources, inclusive. In some embodiments, the subframe partition index is an index to a look-up table. In alternate embodiments, the subframe partition index is an output of an equation, the input to the equation being the size of each individual partition. At step 1120, the base station transmits a second control channel to the mobile station, the second control channel containing at least one communication parameter, the second control channel associated with one of the at least one partitions. The communications parameters are parameters such as those represented by the modulation and coding field and MIMO field of FIG. 9. In some embodiments, the second control channel is transmitted within the resources of the associated at least one partition. At step 1130, the base station communicates with the mobile station using the at least one communication parameter using at least one resource from the associated partition. Communication can be transmitting packets to the mobile station or receiving packets from the mobile station.

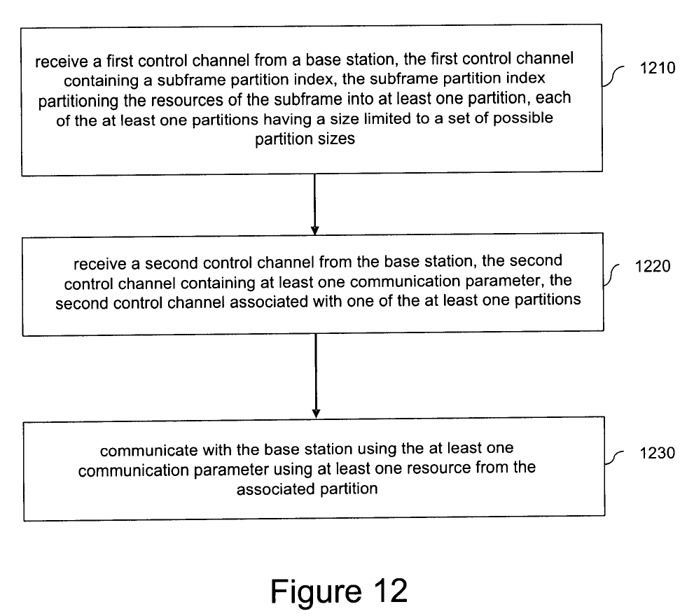

FIG. 12 illustrates a flow chart for mobile station operation in accordance with one embodiment of the present invention. At step 1210, the mobile station receives a first control channel from a base station, where the first control channel has a subframe partition index. The subframe partition index partitions the resources of the subframe into at least one partition. Each of the at least one partitions has a size limited to a set of possible partition sizes. At step 1220, the mobile station receives a second control channel from the base station, where the second control channel has at least one communication parameter. The second control channel is associated with one of the at least one partitions. At step 1230, the mobile station communicates with the base station using the at least one communication parameter using at least one resource from the associated partition.

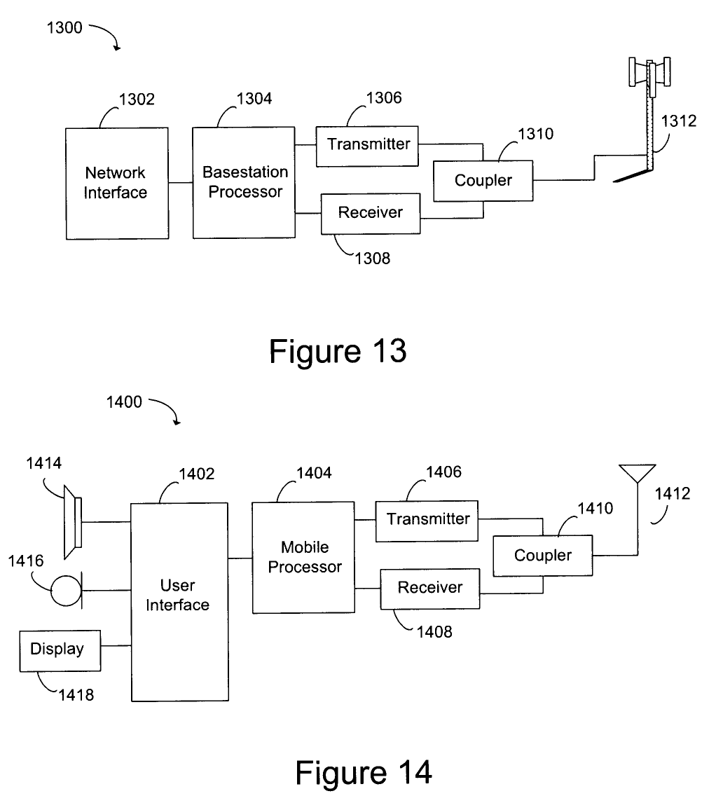

A block diagram of an embodiment base station 1300 is illustrated in FIG. 13. Base station 1300 has a base station processor 1304 coupled to transmitter 1306 and receiver 1308, and network interface 1302. Transmitter 1306 and receiver 1308 are coupled to antenna 1312 via coupler 1310. Base station processor 1304 executes embodiment partition indexing algorithms. In embodiments of the present invention, base station 1300 is configured to operate in a LTE network using an OFDMA downlink channel divided into multiple subbands. In alternative embodiments, other systems, network types and transmission schemes can be used.

A block diagram of an embodiment user device 1400 is illustrated in FIG. 14. User device 1400 can be implemented, for example, as a cellular telephone, or other mobile communication device, such as a computer or network enabled peripheral. Alternatively, user device 1400 can be a non-mobile device, such as a desktop computer with wireless network connectivity. User device 1400 has mobile processor 1404, transmitter 1406 and receiver 1408, which are coupled to antenna 1412 via coupler 1410. User interface 1402 is coupled to mobile processor 1404 and provides interfaces to loudspeaker 1414, microphone 1416 and display 1418, for example. Alternatively, user device 1400 may have a different configuration with respect to user interface 1402, or user interface 1402 may be omitted entirely.

Although present embodiments and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of operating a base station, the method comprising:
transmitting a first control channel to a user device, the first control channel comprising a subframe partition index, the subframe partition index partitioning resources of an associated subframe into at least one partition, wherein the at least one partition comprises a size limited to only a set of possible partition sizes.

2. The method of claim 1, further comprising:
transmitting a second control channel to the user device, the second control channel comprising at least one communication parameter, wherein the second control channel is associated with the at least one partition.

3. The method of claim 2, wherein the at least one communication parameter comprises a modulation and coding assignment.

4. The method of claim 2, further comprising communicating with the user device using the at least one communication parameter, wherein the at least one communication parameter uses at least one resource associated with the at least one partition.

5. The method of claim 2, wherein transmitting the second control channel comprises encoding the at least one communication parameter.

6. The method of claim 5, further comprising encoding the first control channel, wherein encoding the first control channel comprises omitting cyclic redundancy check (CRC) protection to facilitate a low overhead.

7. The method of claim 1, wherein transmitting comprises transmitting on an OFDMA channel.

8. A method of operating a base station, the method comprising:
partitioning resources of an associated subframe into at least one partition;
generating a subframe partition index from a set of equations configured to transform the at least one partition to a corresponding subframe index; and
transmitting a first control channel to a user device, the first control channel comprising the subframe partition index.

9. The method of claim 8, further comprising:
transmitting a second control channel to the user device, the second control channel comprising at least one communication parameter, wherein the second control channel is associated with the at least one partition.

10. The method of claim 9, wherein the at least one communication parameter comprises a modulation and coding assignment.

11. The method of claim 8, wherein generating the subframe partition index from a set of equations comprises evaluating the following set of equations:
$$if a = 0 , b = 0 , I = c$$
$$Else if a = 0 , b > 0 ;$$
$$I = {\sum }_{j = 0}^{b - 1} ( floor ( ( 24 - j ) / 2 ) - j + 1 ) + ( c - b )$$
$$Else if a > 0 , b > 0 ( b > a )$$
$$I = {\sum }_{i = 0}^{a - 1} {\sum }_{j = i}^{floor ( ( 24 - i ) / 3 )} ( floor ( ( 24 - i - j ) / 2 ) - j + 1 ) + {\sum }_{j = a}^{b - 1} ( floor ( ( 24 - a - j ) / 2 ) - j + 1 ) + ( c - b )$$
$$Else if a > 0 , b > 0 , a = b$$
$$I = {\sum }_{i = 0}^{a - 1} {\sum }_{j = i}^{floor ( ( 24 - i ) / 3 )} ( floor ( ( 24 - i - j ) / 2 ) - j + 1 ) + ( c - b ) ,$$
where a, b, and c comprise partition values, I comprises the subframe partition index and d=24−a−b−c.

12. The method of claim 11, wherein evaluation of the set of equations is implemented using the following pseudo-code function:
int function(int a, int b , int c , int d)
{
int result = 0;
if(a==0 && b==0)
{
result = c;
}
else if(a==0 && b>0)
{
for(int j=0; j<b ; j++)
{
result = result+((24−j)/2−j+1);
}
result = result+(c−b);
}
else if(a>0 && b>0)
{
if(b>a)
{
for(int i = 0 ; i < a ; i++)
{
for(int j=i; j <= (24−i)/3 ; j ++)
{
result = result +((24−i−j)/2−j+1);
}
}
for(int j=a; j < b ; j++)
{
result = result + ((24−a−j)/2−j+1);
}
result = result + (c−b);
}
else if (a==b)
{
for(int i = 0 ; i < a ; i++)
{
for(int j = i ; j <= (24−i)/3 ; j++)
{
result = result + ((24−i−j)/2−j+1);
}
}
result = result + (c−b);
}
else
{
cout<<“ error! ”<<endl;
}
}
else
{
cout<<“ error! ”<<endl;
}
return result;
}.

13. The method of claim 8, wherein generating the subframe partition index from a set of equations comprises evaluating the following set of equations:
$$if a = 0 , b = 0 , c = 0 I = d ;$$
$$Else if a = 0 , b = 0 , c > 0$$
$$I = {\sum }_{i = 0}^{c - 1} ( floor ( ( M - i ) / 2 ) - i + 1 ) + ( d - c ) ;$$
$$Else if a = 0 , b > 0 , c > 0 , b = c$$
$$I = {\sum }_{i = 0}^{b - 1} {\sum }_{j = i}^{floor ( ( M - i ) / 3 )} ( floor ( ( M - i - j ) / 2 ) - j + 1 ) + ( d - c ) ;$$
$$Else if a = 0 , b > 0 , c > 0 , b < c$$
$$I = {\sum }_{i = 0}^{b - 1} {\sum }_{j = i}^{floor ( ( M - i ) / 3 )} ( floor ( ( M - i - j ) / 2 ) - j + 1 ) + {\sum }_{j = b}^{c - 1} ( floor ( M - b - j ) / 2 - j + 1 ) + ( d - c )$$
$$Else if a > 0 , b > 0 , c > 0 \&\& a = b = c$$
$$I = {\sum }_{i = 0}^{a - 1} {\sum }_{j - i}^{floor ( ( M - i ) / 4 )} {\sum }_{k = j}^{floor ( ( M - i - j ) / 3 )} ( floor ( M - i - j - k ) / 2 - k + 1 ) + ( d - c )$$
$$Else if a > 0 , b > 0 , c > 0 \&\& a = b < c$$
$$I = {\sum }_{i = 0}^{a - 1} {\sum }_{j - i}^{floor ( ( M - i ) / 4 )} {\sum }_{k = j}^{floor ( ( M - i - j ) / 3 )} ( floor ( M - i - j - k ) / 2 - k + 1 ) + {\sum }_{k = a}^{c - 1} ( floor ( ( M - a - b - k ) / 2 ) - k + 1 ) + ( d - c )$$
$$Else if a > 0 , b > 0 , c > 0 \&\& a < b < c$$
$$I = {\sum }_{i = 0}^{a - 1} {\sum }_{j - i}^{floor ( ( M - i ) / 4 )} {\sum }_{k = j}^{floor ( ( M - i - j ) / 3 )} ( floor ( M - i - j - k ) / 2 - k + 1 ) + {\sum }_{k = b}^{c - 1} ( floor ( ( M - a - b - k ) / 2 ) - k + 1 ) + {\sum }_{j = a}^{b - 1} {\sum }_{k = j}^{floor ( ( M - a - j ) / 3 )} floor ( ( M - a - j - k ) / 2 - k + 1 ) + ( d - c )$$
$$Else if a > 0 , b > 0 , c > 0 \&\& a < b = c$$
$$I = {\sum }_{i = 0}^{a - 1} {\sum }_{j - i}^{floor ( ( M - i ) / 4 )} {\sum }_{k = j}^{floor ( ( M - i - j ) / 3 )} ( floor ( M - i - j - k ) / 2 - k + 1 ) + {\sum }_{j = a}^{b - 1} {\sum }_{k = j}^{floor ( ( M - a - j ) / 3 )} floor ( ( M - a - j - k ) / 2 - k + 1 ) + ( d - c )$$
where a, b, c and d comprise partition sizes, M comprises a number of subchannels, and I comprises the subframe partition index, and e=M−a−b−c−e.

14. The method of claim 13, wherein evaluation of set of equations is implemented using the following pseudo-code function:
int func(int a, int b, int c, int d, int e, int M)
{
int result = 0;
if(a==0 && b ==0 && c==0)
{
result = d;
}
else if(a==0 && b ==0 && c>0)
{
for(int i =0 ; i < c ; i++)
{
result = result + ((M−i)/2−i+1);
}
result = result + (d−c);
}
else if(a==0 && b> 0 && c>0)
{
if(b==c)
{
for(int i=0; i < b ; i++)
{
for(int j = i ; j <=(M−i)/3 ; j++)
{
result = result+ (M−i−j)/2 −j+1;
}
}
result = result + (d−c);
}
else if(b<c)
{
for(int i = 0 ; i < b ; i++)
{
for(int j = i ; j <= (M−i)/3; j++)
{
result = result + (M−i−j)/2 − j + 1;
}
}
for(int j = b ; j < c ; j++)
{
result = result + ((M−b−j)/2 −j +1);
}
result = result + (d−c);
}
}
else if (a >0 && b >0 && c >0)
{
if(a==b && b==c)
{
for(int i = 0 ; i < a ; i++)
{
for(int j = i ; j <= (M−i)/4 ; j++)
{
for(int k = j ; k <= (M−i−j)/3 ; k++)
{
result = result + (M−i−j−k)/2−k+1;
}
}
}
result = result + (d−c);
}
else if(a==b && b < c)
{
for(int i = 0 ; i < a ; i++)
{
for(int j = i ; j <=(M−i)/4 ; j++)
{
for(int k = j ; k <=(M−i−j)/3 ; k++)
{
result = result + (M−i−j−k)/2 −k+1;
}
}
}
for(int k = a ; k < c ; k++)
{
result = result + (M−a−b−k)/2 − k+1;
}
result = result + (d−c);
}
else if( a < b && b < c)
{
for(int i = 0 ; i < a ; i++)
{
for(int j = i ; j <=(M−i)/4 ; j++)
{
for(int k = j ; k <=(M−i−j)/3 ; k++)
{
result = result + (M−i−j−k)/2 −k+1;
}
}
}
for(int j = a ; j < b ; j++)
{
for(int k = j ; k <= (M − a−j)/3 ; k++)
{
result = result + (M−a−j−k)/2 − k+1;
}
}
for( int k = b ; k < c ; k++)
{
result = result + (M−a−b−k)/2 − k+1;
}
result = result + (d−c);
}
else if(a < b && b == c)
{
for(int i = 0 ; i < a ; i++)
{
for(int j = i ; j <=(M−i)/4 ; j++)
{
for(int k = j ; k <=(M−i−j)/3 ; k++)
{
result = result + (M−i−j−k)/2 −k+1;
}
}
}
for(int j = a ; j < b ; j++)
{
for(int k = j ; k <= (M − a−j)/3 ; k++)
{
result = result + (M−a−j−k)/2 − k+1;
}
}
result = result + (d−c);
}
else
{
cout<<“ error set!”<<endl;
}
}
return result;
}.

15. A wireless base station comprising:
a transmitter configured to transmit a first control channel to a user device, wherein
the first control channel comprises a subframe partition index,
the subframe partition index partitions resources of an associated subframe into at least one partition, and
the at least one partition comprises a size limited to only a set of possible partition sizes.

16. The method of claim 15, wherein:
the transmitter is further configured to transmit a second control channel to the user device, the second control channel comprising at least one communication parameter, wherein the second control channel is associated with the at least one partition; and
the wireless base station is configured to communicate with the user device using the at least one communication parameter, wherein the at least one communication parameter uses at least one resource associated with the at least one partition, and encode the at least one communication parameter.

17. The method of claim 16, wherein the wireless base station is further configured to encode the first control channel, and cyclic redundancy check (CRC) protection is omitted when the first control channel is being encoded.

18. The method of claim 15, wherein the transmitter is configured to transmit using an OFDMA channel.

19. A wireless base station comprising:
a transmitter configured to transmit a first control channel to a user device, wherein the first control channel comprises a subframe partition index,
the subframe partition index partitions resources of an associated subframe into at least one partition, wherein the wireless base station is configured to generate the subframe partition index from a set of equations and the sizes of the least one partition.

20. The wireless base station of claim 19, wherein the set of equations comprises:
$$if a = 0 , b = 0 , I = c$$
$$Else if a = 0 , b > 0 ;$$
$$I = {\sum }_{j = 0}^{b - 1} ( floor ( ( M - j ) / 2 ) - j + 1 ) + ( c - b )$$
$$Else if a > 0 , b > 0 ( b > a )$$
$$I = {\sum }_{i = 0}^{a - 1} {\sum }_{j = i}^{floor ( ( M - i ) / 3 )} ( floor ( ( M - i - j ) / 2 ) - j + 1 ) + {\sum }_{j = a}^{b - 1} ( floor ( ( M - a - j ) / 2 ) - j + 1 ) + ( c - b )$$
$$Else if a > 0 , b > 0 , a = b$$
$$I = {\sum }_{i = 0}^{a - 1} {\sum }_{j = i}^{floor ( ( M - i ) / 3 )} ( floor ( ( M - i - j ) / 2 ) - j + 1 ) + ( c - b ) ,$$
where a, b, and c comprise partition values, I comprises the subframe partition index, and M comprises the number of sub-channels d=M−a−b−c.

21. The wireless base station of claim 20, wherein M=24.
